(19) United States
(12) Patent Application Publication
(10) Pub. No.: US 2014/0122598 A1
(43) Pub. Date: May 1, 2014

(54) PEER-TO-PEER BASED MESSAGE TRANSMITTING METHOD FOR NETWORK SYSTEM AND NETWORK SYSTEM THEREOF

(71) Applicant: Wistron Corporation, New Taipei City (TW)

(72) Inventors: Wei-Cherng Liao, New Taipei City (TW); Pei-Ling Yu, New Taipei City (TW); Alexander I-Chi Lai, New Taipei City (TW)

(73) Assignee: Wistron Corporation, New Taipei City (TW)

(21) Appl. No.: 14/062,871

(22) Filed: Oct. 24, 2013

(30) Foreign Application Priority Data
Oct. 26, 2012 (TW) 101139696

(51) Int. Cl. H04L 29/08

(52) U.S. Cl. CPC H04L 67/104
USPC 709/204

(57) ABSTRACT

A peer-to-peer based message transmitting method for a network system includes a plurality of clients and a management device. The method includes receiving a first message by the management device; adding information to the first message which is related to a plurality of target clients corresponding to the first message by the management device, in order to generate a second message; and transmitting the second message to the plurality of target clients by the management device.

### BACKGROUND OF THE INVENTION

1. Field of the Invention

The present invention relates to a peer-to-peer based message transmitting method for a network system and the network system thereof, and more particularly, to a peer-to-peer based message transmitting method for a network system and the network system thereof, capable of reducing load of a management device in the network system, and ensuring that all clients can receive desired messages, in order to improve performance and reliability of message transmission.

2. Description of the Prior Art

There are usually a large number of messages transmitted in a network system. With advances in data processing techniques, the quantity of transmitted data becomes even larger, such that different communication protocols are developed in the industry for specifying methods of transmitting data and messages. One method specifies the transmission of a specific message to a specific client, where the message is transmitted to a specific location defined by the Internet Protocol (IP), in order to ensure that the specific client can receive the message. Another method comprises the message being transmitted to the network system by broadcasting, where the message is transmitted randomly via routers; hence all clients in the network system may receive this message. Once received, the clients may retain or discard this message.

Please refer to FIG. 1, which is a schematic diagram of a common network system 10. As shown in FIG. 1, the network system 10 includes a management device 110 and clients C₁-C_{N}. The management device 110 is generally a server for managing all of the clients C₁-C_{N} and transmitting messages to the clients C₁-C_{N}. For example, if a client C₃ needs to transmit a message Msg_{C} to a client C₂, the client C₃ first transmits the message Msg_{c} to the management device 110, and the management device 110 then transmits the message Msg_{C} to the client C₂. The same message may be transmitted to multiple clients. For example, when clients C₁, C₃ and C₄ all subscribe to a message Msg_{A} from the management device 110, the management device 110 transmits the message Msg_{A} to the clients C₁, C₃ and C₄, respectively.

Although the method of transmitting the specific message to the specific client by the management device 110 ensures that all clients can receive the message, the load is entirely imposed on the management device 110, such that the management device 110 has the burden of performance of the entire network system 10. For example, if a message needs to be transmitted to one hundred clients, the management device 110 has to repeatedly transmit the message one hundred times, which reduces the performance. In order to solve the problem, another conventional method comprises the management device 110 broadcasting the message to the network system 10, where the message is transmitted between the clients C₁-C_{N} randomly. Though the load of the management device 110 can be reduced significantly, it cannot ensure that all of the clients C₁-C_{N} can receive a desired message, and the reliability of the network system 10 is reduced. Therefore, there is a need for providing a message transmitting method which gives consideration to both the performance and reliability of the network system.

### SUMMARY OF THE INVENTION

It is therefore an objective of the present invention to provide a peer-to-peer based message transmitting method for a network system and the network system thereof, capable of reducing load of a management device in the network system, and ensuring that all clients can receive desired messages, in order to improve performance and reliability of message transmission.

The present invention discloses a peer-to-peer based message transmitting method for a network system comprising a plurality of clients and a management device. The method comprises: the management device receiving a first message; the management device adding information to the first message which is related to a plurality of target clients corresponding to the first message, in order to generate a second message; and the management device transmitting the second message to the plurality of target clients.

The present invention further discloses a network system, which comprises a plurality of clients and a management device. The management device comprises a processor and a storage device, where the storage device stores a program for instructing the processor to execute the method comprising: receiving a first message; adding information to the first message, the information related to a plurality of target clients corresponding to the first message, in order to generate a second message; and transmitting the second message to the plurality of target clients.

The present invention further discloses a peer-to-peer based message transmitting method for a network system comprising a plurality of clients and a management device. The method comprises the management device receiving information related to a plurality of target clients corresponding to a first message when a client among the plurality of clients sends the first message to the plurality of target clients; and the management device controlling the client to transmit the first message to the plurality of target clients.

The present invention further discloses a network system comprising a plurality of clients and a management device. The management device comprises a processor and a storage device, where the storage device stores a program for instructing the processor to execute the method comprising: receiving information related to a plurality of target clients corresponding to a first message when a client among the plurality of clients sends the first message to the plurality of target clients; and controlling the client to transmit the first message to the plurality of target clients.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a common network system.

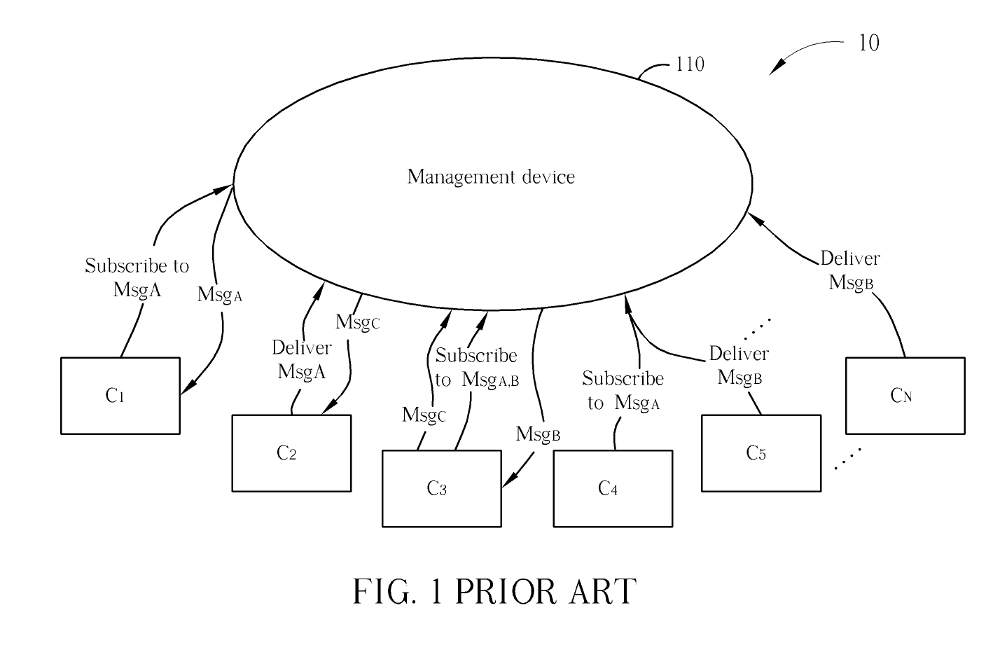

FIG. 2 is a schematic diagram of a network system according to an embodiment of the present invention.

FIG. 3 illustrates the management device and partial clients shown in FIG. 2.

FIG. 4 is a schematic diagram of a peer-to-peer based message transmitting process according to an embodiment of the present invention.

FIG. 5 is a schematic diagram of a new client communicating with the management device when entering the network system according to an embodiment of the present invention.

FIG. 6 is a schematic diagram of an entering process according to an embodiment of the present invention.

FIG. 7 is a schematic diagram of another network system according to an embodiment of the present invention.

FIG. 8 illustrates the management device and partial clients shown in FIG. 7.

FIG. 9 is a schematic diagram of another peer-to-peer based message transmitting process according to an embodiment of the present invention.

### DETAILED DESCRIPTION

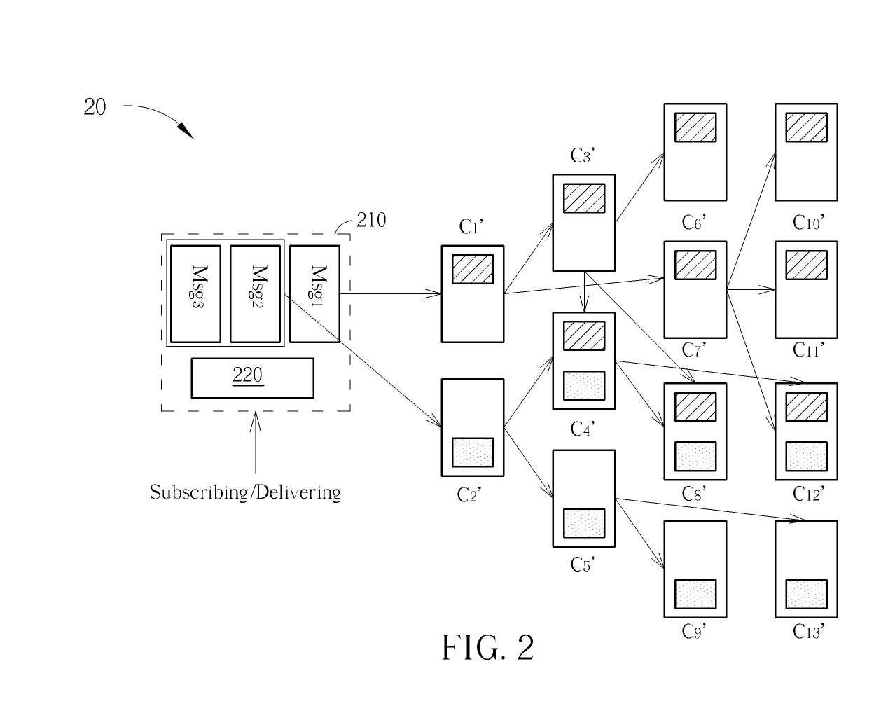

Please refer to FIG. 2, which is a schematic diagram of a network system 20 according to an embodiment of the present invention. As shown in FIG. 2, the network system 20 includes a management device 210 and clients C₁′-C₁₃′. The management device 210 includes a program 220, which is utilized for processing tasks related to message transmission and managing all of the clients C₁′-C₁₃′. The main difference between the management device 210 and the management device 110 is that when a message needs to be transmitted, the management device 110 transmits the message to all of the clients subscribing to this message, but the management device 210 only transmits the message to partial clients subscribing to this message, and the clients which receive this message then transmit this message to other clients which have subscribed to this message but not yet received this message. For example, as shown in FIG. 2, the management device 210 only needs to transmit messages Msg₁ and Msg₂, Msg₃ to the clients C₁′ and C₂′, respectively, and the clients C₁′ and C₂′ then transmit the messages Msg₁ and Msg₂, Msg₃ through a peer-to-peer based method, respectively. As a result, the clients C₁′-C₁₃′ share partial tasks related to message transmission of the management device 210, such that the load of the management device 210 can be reduced significantly.

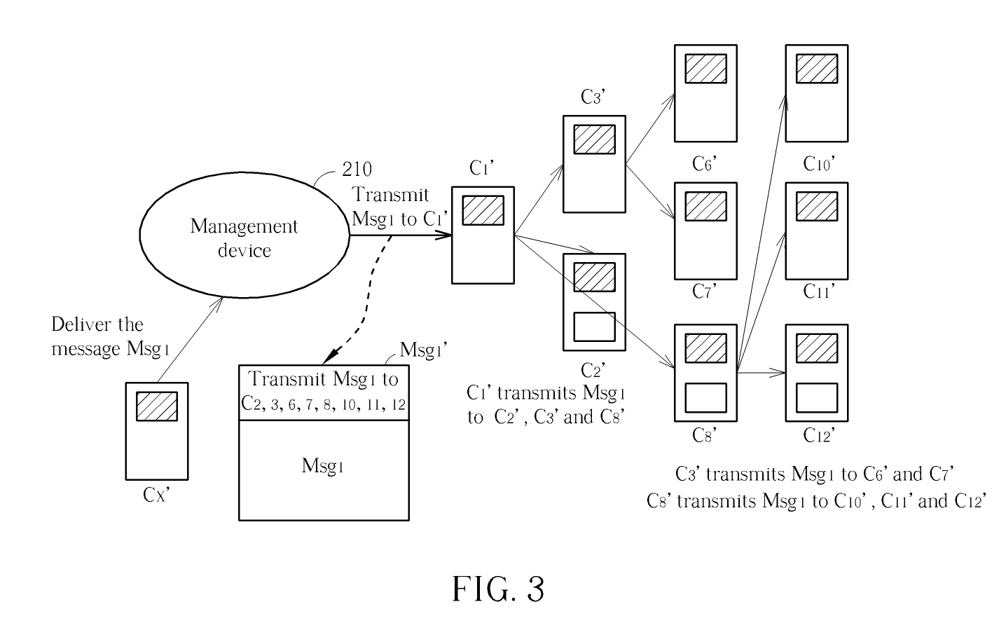

In detail, since the clients C₁′-C₁₃′ can share partial tasks related to message transmission of the management device 210, the management device 210 is mainly responsible for receiving the messages delivered by the clients C₁′-C₁₃′, and managing the message subscription by each of the clients C₁′-C₁₃′. The management device 210 further ensures that all of the clients C₁′-C₁₃′ can receive desired messages, in order to maintain reliability of the network system 20. Please refer to FIG. 3, which illustrates the management device 210 and partial clients shown in FIG. 2. In FIG. 3, only the clients subscribing to the message Msg₁ are illustrated for clear reference. When a client C_{X}′ delivers the message Msg₁, the message Msg₁ is transmitted to the management device 210 directly. After receiving the message Msg₁, the management device 210 may put information related to the clients subscribing to the message Msg₁ into the message Msg₁ as a preamble, in order to generate a message Msg₁′. The management device 210 then transmits the message Msg₁′ to the client C₁′. After receiving the message Msg₁′, the client C₁′ learns through the preamble that the message Msg₁′ needs to be transmitted to the clients C₂′, C₃′ and C₈′, and perform the transmission accordingly. In the same way, the clients C₃′ and C₈′ respectively learn through the preamble that the message Msg₁′ needs to be transmitted to the clients C₆′, C₇′ and C₁₀′, C₁₁′, C₁₂′, and perform the transmission accordingly. Therefore, the management device 210 only needs to transmit the message Msg₁ to some of the clients subscribing to the message Msg₁. All of the clients subscribing to the message Msg₁ are divided into several levels, such that some clients can transmit the message to others level by level. After any of the clients C₁′-C₁₃′ receives the message, it can learn through the preamble that the message further needs to be transmitted to other clients. As a result, the embodiment can ensure that all of the clients C₁′-C₁₃′ can receive the desired messages.

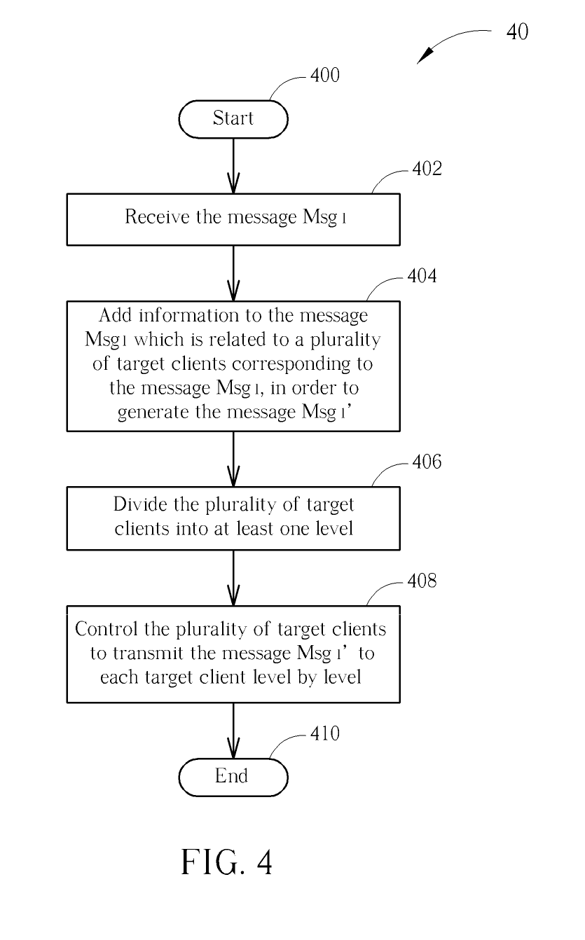

The above operation of the program 220 in the management device 210 can be summarized into a peer-to-peer based message transmitting process 40. As shown in FIG. 4, the peer-to-peer based message transmitting process 40 includes the following steps:

Step 400: Start.

Step 402: Receive the message Msg₁.

Step 404: Add information to the message Msg₁ which is related to a plurality of target clients corresponding to the message Msg₁, in order to generate the message Msg₁′.

Step 406: Divide the plurality of target clients into at least one level.

Step 408: Control the plurality of target clients to transmit the message Msg₁′ to each target client level by level.

Step 410: End.

Please note that, in order to ensure that all of the clients C₁′-C₁₃′ can receive the desired message, the management device 210 has to know information related to all of the clients C₁′-C₁₃′. The information may include characteristics of each of the clients C₁′-C₁₃′ such as location, types of subscribed messages, transmitting performance, etc. The management device 210 can select the method of transmitting messages between the clients C₁′-C₁₃′ arbitrarily, in order to achieve the best message transmission performance of the network system 20. For example, the client closer to the management device 210 or having better channel quality may be put into a higher level; the client with higher transmitting performance can perform more tasks, and thus more target clients are put into the level following the level of this client; the client with a weaker transmitting performance can only perform a few tasks, and thus fewer target clients are put into the level following the level of this client.

In order to enhance the performance of message transmission, the management device 210 may also merge the messages and then perform the transmission. Therefore, a message received by the clients C₁′-C₁₃′ may be composed of a plurality of different sub-messages. For example, as shown in FIG. 2, the message received by the client C₂′ is composed of the messages Msg₂, Msg₃. As a result, when two messages both need to be transmitted to the clients C₁′-C₁₃′, if there are many same clients subscribing to these two messages (i.e. the target clients are similar or the same), these two messages can be merged into a larger message, and then sent to the target clients subscribing to these two messages. The management device 210 can determine whether to merge the messages and then perform the transmission according to system requirements, in order to achieve the highest message transmission performance of the network system 20.

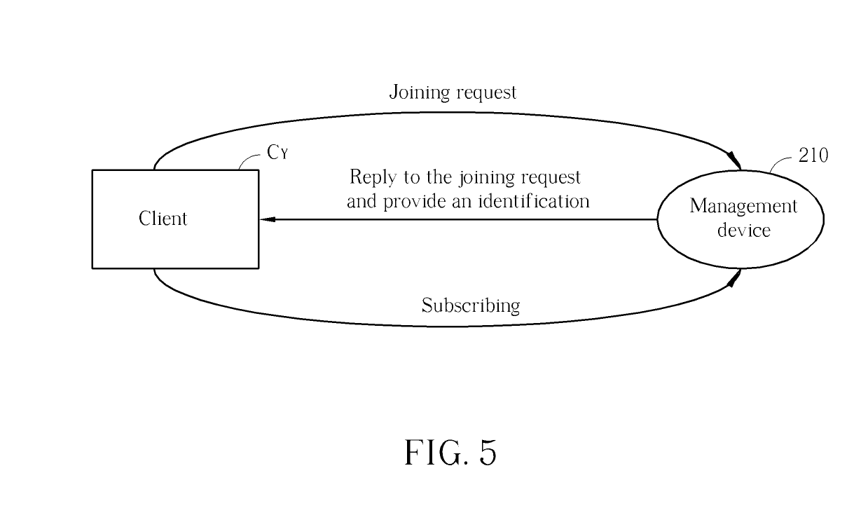

In addition, when a new client needs to enter the network system 20, the management device 210 manages the new client as well. Please refer to FIG. 5, which is a schematic diagram of a new client C_{Y} communicating with the management device 210 when entering the network system 20 according to an embodiment of the present invention. As shown in FIG. 5, when the new client C_{Y} needs to enter the network system 20, the new client C_{Y} first sends a joining request to the management device 210, and the management device 210 obtains information related to the client C_{Y} such as location, transmitting performance, etc. After agreeing to let the client C_{Y} enter the network system 20, the management device 210 may reply to the joining request and provide an identification for the client C_{Y}. The client C_{Y} then subscribes to the messages of interest from the management device 210, and performs the follow-up peer-to-peer based message transmission.

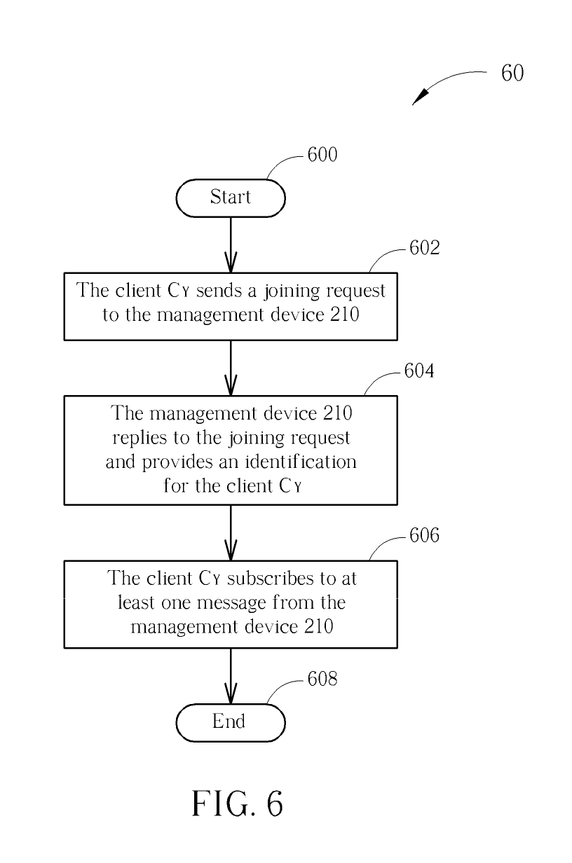

The above operation related to the client C_{Y} entering the network system 20 can be summarized into an entering process 60. As shown in FIG. 6, the entering process 60 includes the following steps:

Step 600: Start.

Step 602: The client C_{Y} sends a joining request to the management device 210.

Step 604: The management device 210 replies to the joining request and provides an identification for the client C_{Y}.

Step 606: The client C_{Y} subscribes to at least one message from the management device 210.

Step 608: End.

Please note that the spirit of the present invention is to reduce the load of the management device in the network system and to ensure that all clients can receive their desired messages, in order to improve performance and reliability of message transmission. Those skilled in the art can make modifications and alterations accordingly. For example, in the above embodiments, the management device 210 puts the information related to the clients subscribing to the message Msg₁ into a preamble, but in other embodiments, other methods may also be utilized for combining the message Msg₁ with the information related to the clients. In some embodiments, before transmitting the message Msg₁ to the management device 210, the client can add information related to the target clients in the message Msg₁, which is not limited herein. In the above embodiments, all of the messages are transmitted to the management device 210 first, and then the management device 210 transmits the messages to the clients C₁′-C₁₃′ level by level; that is, through a peer-to-peer based method. In other embodiments, however, the messages may not be transmitted via the management device 210, and the transmission is performed directly between the clients C₁′-C₁₃′, such that the load of the management device 210 is further reduced, in order to improve the performance of the network system 20.

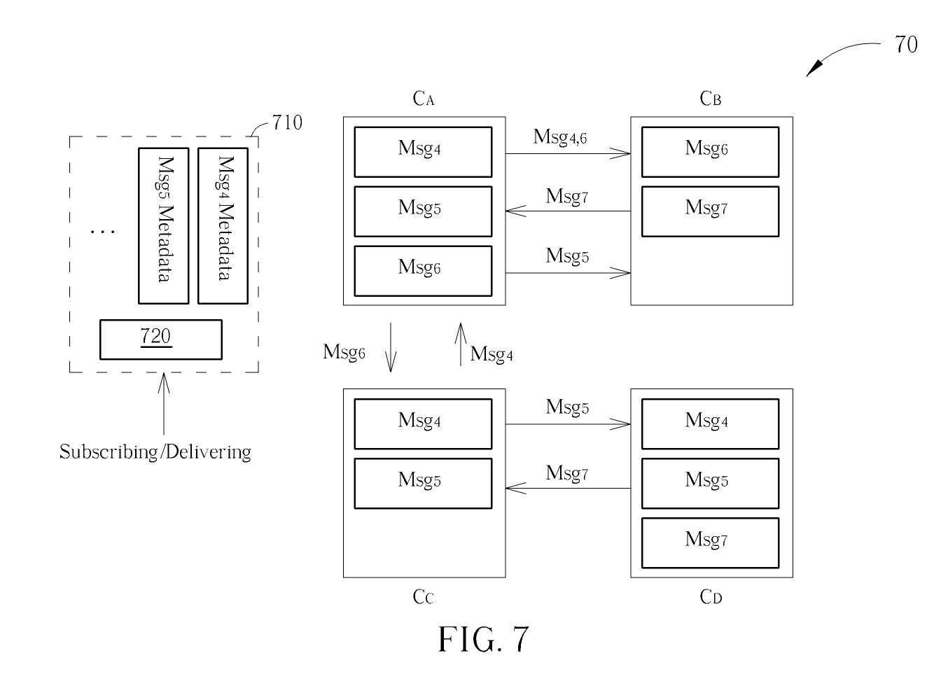

Please refer to FIG. 7, which is a schematic diagram of another network system 70 according to an embodiment of the present invention. As shown in FIG. 7, the network system 70 includes a management device 710 and clients C_{A}-C_{D}. The management device 710 includes a program 720, which is utilized for managing all of the clients C_{A}-C_{D}. The main difference between the management device 710 and the management device 210 is that, in the network system 70, all messages are transmitted between the clients C_{A}-C_{D} and not via the management device 710. The management device 710 only receives information related to the clients C_{A}-C_{D} such as subscribing, transmission, etc. For example, in FIG. 7, the messages Msg₄-Msg₇ are transmitted between the clients C_{A}-C_{D} and not via the management device 710, and the management device 710 only processes the metadata of each of the messages Msg₄-Msg₇ (i.e. information related to the messages such as subscribing, delivering, and transmission, etc.). As a result, the clients C_{A}-C_{D} share all tasks related to message transmission of the management device 710, such that the load of the management device 710 can be reduced significantly.

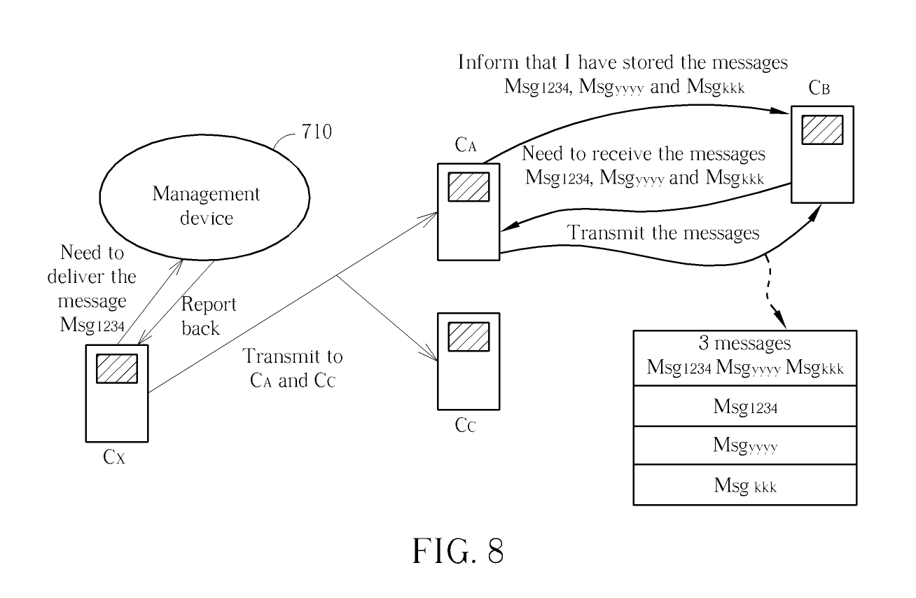

In detail, since the messages Msg₄-Msg₇ are transmitted between the clients C_{A}-C_{D} and not via the management device 710, the management device 710 is mainly responsible for managing the types of the messages subscribed to, delivered and transmitted by each of the clients C_{A}-C_{D}, and ensuring that all of the clients C_{A}-C_{D} can receive the desired message, in order to maintain reliability of the network system 70. Please refer to FIG. 8, which illustrates the management device 710 and partial clients shown in FIG. 7. As shown in FIG. 8, when the client C_{X} needs to deliver a message Msg₁₂₃₄, the client C_{X} first informs the management device 710. The management device 710 learns that the clients C_{A} and C_{C} have subscribed to the message Msg₁₂₃₄, according to the information related to subscribing of the clients C_{A} and C_{C} or other information, and reports back to the client C. In some embodiments, the client C_{X} knows that the message Msg₁₂₃₄ is required to be transmitted to the client C_{A} and C_{C}; in this case, the management device 710 does not need to report back to the client C. The client C_{X} then transmits the message Msg₁₂₃₄ to the clients C_{A} and C_{C} directly, and not via the management device 710.

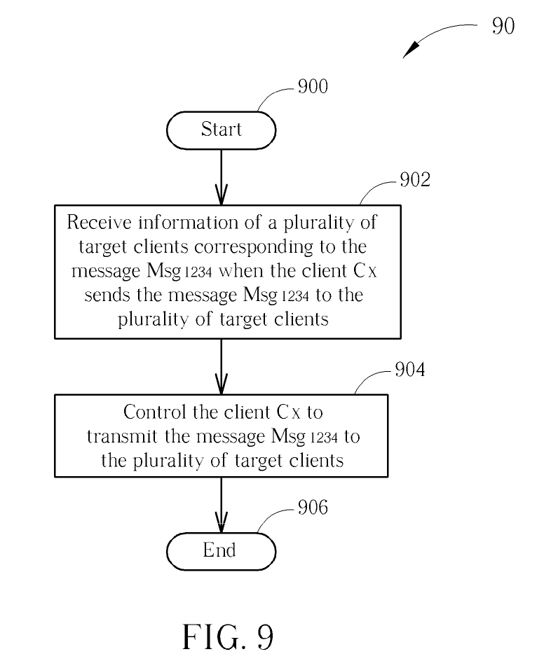

The above operation of the program 720 in the management device 710 can be summarized into another peer-to-peer based message transmitting process 90. As shown in FIG. 9, the peer-to-peer based message transmitting process 90 includes the following steps:

Step 900: Start.

Step 902: Receive information of a plurality of target clients corresponding to the message Msg₁₂₃₄ when the client C_{X} sends the message Msg₁₂₃₄ to the plurality of target clients.

Step 904: Control the client C_{X} to transmit the message Msg₁₂₃₄ to the plurality of target clients.

Step 906: End.

The process 90 can also be combined with Steps 406 and 408 of the process 40, in order to transmit the message Msg₁₂₃₄ to the target client in each level through a peer-to-peer based method according to the level in which the client C_{X} is located. The management device 710 can select the method of transmitting the message Msg₁₂₃₄ between the clients C_{A}-C_{D} arbitrarily, in order to achieve the best message transmission performance of the network system 70. The steps related to the new client C_{Y} entering the network system 20 stated in the process 60 can also be integrated into the network system 70; such a procedure should be well known by those skilled in the art, and will not be narrated herein.

In some embodiments, messages are transmitted between the clients one-on-one and not via the management device 710. For example, as shown in FIG. 8, the client C_{A} informs the client C_{B} that the client C_{A} has stored the messages Msg₁₂₃₄, Msg_{yyyy}, Msgₖₖₖ, etc. If the client C_{B} needs to receive the messages Msg₁₂₃₄, Msg_{yyyy} and Msgₖₖₖ, the client C_{B} replies to the client C_{A}. The client C_{A} then merges the messages Msg₁₂₃₄, Msg_{yyyy} and Msgₖₖₖ into a larger message, which is transmitted to the client C_{B} directly and not via the management device 710. As can be seen, in addition to all tasks related to message transmission of the management device 710, the tasks of merging messages can also be performed by the clients C_{A}-C_{D}. As a result, the load of the management device 710 can further be reduced, in order to improve the performance of the network system 70.

In the prior art, though the method of transmitting the specific message to the specific client by the management device ensures that all of the clients can receive the message, the load is entirely imposed on the management device, such that the management device always bears the performance burden of the entire network system. If the management device broadcasts the message to the network system, the message is transmitted between the clients randomly. Through this method, though the load of the management device can be reduced significantly, it cannot ensure that all of the clients can receive a desired message, such that the reliability of the network system is reduced. In comparison, according to the present invention, the messages can be transmitted to different clients level by level or through a peer-to-peer based method, which can reduce the load of the management device in the network system and ensure that all of the clients can receive the desired messages, in order to improve the performance and reliability of message transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A peer-to-peer based message transmitting method for a network system comprising a plurality of clients and a management device, the method comprising:
receiving a first message;
adding information to the first message which is related to a plurality of target clients corresponding to the first message, in order to generate a second message; and
transmitting the second message to the plurality of target clients;
wherein the management device indirectly transmits a specific message to a client among the plurality of clients via other clients among the plurality of clients when the client subscribes to the specific message.

2. The method of claim 1, wherein the step of the management device transmitting the second message to the plurality of target clients comprises:
the management device dividing the plurality of target clients into at least one level; and
the management device controlling the plurality of target clients to transmit the second message to each target client level by level.

3. The method of claim 2, wherein the first message is delivered by a client among the plurality of clients.

4. The method of claim 2, wherein the first message comprises a plurality of sub-messages and each sub-message is delivered by a client among the plurality of clients.

5. The method of claim 1, further comprising:
a client sending a joining request to the management device;
the management device replying to the joining request and providing an identification for the client; and
the client subscribing to at least one message from the management device.

6. A network system, comprising:
a plurality of clients; and
a management device, comprising a processor and a storage device, the storage device storing a program for instructing the processor to execute:
receiving a first message;
adding information to the first message which is related to a plurality of target clients corresponding to the first message, in order to generate a second message; and
transmitting the second message to the plurality of target clients;
wherein the management device indirectly transmits a specific message to a client among the plurality of clients via other clients among the plurality of clients when the client subscribes to the specific message.

7. The network system of claim 6, wherein the step of transmitting the second message to the plurality of target clients comprises:
dividing the plurality of target clients into at least one level; and
controlling the plurality of target clients to transmit the second message to each target client level by level.

8. The network system of claim 7, wherein the first message is delivered by a client among the plurality of clients.

9. The network system of claim 7, wherein the first message comprises a plurality of sub-messages and each sub-message is delivered by a client among the plurality of clients.

10. The network system of claim 6, wherein the program further indicates the processor to execute:
a client sending a joining request to the management device;
the management device replying to the joining request and providing an identification for the client; and
the client subscribing to at least one message from the management device.

11. A peer-to-peer based message transmitting method for a network system comprising a plurality of clients and a management device, the method comprising:
the management device receiving information related to a plurality of target clients corresponding to a first message when a client among the plurality of clients sends the first message to the plurality of target clients; and
the management device controlling the client to transmit the first message to the plurality of target clients.

12. The method of claim 11, wherein the step of the management device controlling the client to transmit the first message to the plurality of target clients comprises:
the management device dividing the plurality of target clients into at least one level; and
the management device controlling the client and the plurality of target clients to transmit the first message to each target client level by level.

13. The method of claim 12, further comprising:
the management device controlling a client among the plurality of clients to integrate a plurality of messages and then to transmit an integrated message to another client when the client is required to transmit the plurality of messages to the another client.

14. The method of claim 12, wherein the management device indirectly controls other clients among the plurality of clients to transmit a specific message to a client among the plurality of clients when the client subscribes to the specific message.

15. The method of claim 11, further comprising:
a client sending a joining request to the management device;
the management device replying to the joining request and providing an identification for the client; and
the client subscribing to at least one message from the management device.

16. A network system, comprising:
a plurality of clients; and
a management device, comprising a processor and a storage device, the storage device storing a program for instructing the processor to execute:
receiving information related to a plurality of target clients corresponding to a first message when a client among the plurality of clients sends the first message to the plurality of target clients; and
controlling the client to transmit the first message to the plurality of target clients.

17. The network system of claim 16, wherein the step of controlling the client to transmit the first message to the plurality of target clients comprises:
dividing the plurality of target clients into at least one level; and
controlling the client and the plurality of target clients to transmit the first message to each target client level by level.

18. The network system of claim 17, wherein the program further indicates the processor to execute:
controlling a client among the plurality of clients to integrate a plurality of messages and then to transmit an integrated message to another client when the client is required to transmit the plurality of messages to the another client.

19. The network system of claim 17, wherein the management device indirectly controls other clients among the plurality of clients to transmit a specific message to a client among the plurality of clients when the client subscribes to the specific message.

20. The network system of claim 16, wherein the program further indicates the processor to execute:
a client sending a joining request to the management device;
the management device replying to the joining request and providing an identification for the client; and
the client subscribing to at least one message from the management device.
